(19) United States
(12) Patent Application Publication
(10) Pub. No.: US 2017/0008221 A1
(43) Pub. Date: Jan. 12, 2017

(54) FIBER-REINFORCED THERMOSETTING PLASTIC COMPONENT WITH A FUNCTIONAL LAYER FOR CONNECTING TO A THERMOPLASTIC COMPONENT

(71) Applicant: KTM TECHNOLOGIES GMBH, Salzburg/Anif (AT)

(72) Inventors: Florian Huber, Grassau (DE); Martin Mitterer, Bad Reichenhall (DE); Hans Lochner, Ramsau (DE); Peter Martin, Saaldorf-Surheim (DE)

(21) Appl. No.: 15/107,328

(22) PCT Filed: Dec. 22, 2014
(86) PCT No.: PCT/EP2014/078981

§ 371 Date: Jun. 22, 2016

(30) Foreign Application Priority Data
Dec. 23, 2013 (DE) 10 2013 114 829.8

(51) Int. Cl. B29C 65/00; B29C 65/02

(52) U.S. Cl. CPC B29C 65/006; B29C 65/02; B29K 2101/10

(57) ABSTRACT

A method for joining a thermoset plastic component and a thermoplastic component by bonding includes interconnecting the two components via a functional layer of the thermoset plastic component. The thermoplastic component is directly applied to the functional layer of the thermoset plastic component, such that a diffusion region is formed between the thermoplastic component and the functional layer of the thermoset plastic component.

### CROSS-REFERENCE TO RELATED APPLICATIONS

This application is a national stage of International Application No. PCT/EP2014/078981, filed Dec. 22, 2014 and claims benefit to German Patent Application No. 10 2013 114 829.8 filed Dec. 23, 2013, both of which are incorporated by reference herein.

### TECHNICAL FIELD

The present disclosure relates to a manufacturing method for a fiber-reinforced thermosetting plastic component that can be joined with a firm bond to a thermoplastic component, especially by welding, in which, to create a main body, reinforcement fibers are introduced to a hardening device with a viscous thermoplastic matrix that is hardened and/or cured under pressure and/or heat, wherein before or after this hardening process to coat the main body, at least in one joining area provided to be joined to the thermoplastic component, a functional layer is arranged on the viscous thermoplastic matrix and/or the reinforcement fibers that bonds firmly to the thermosetting matrix and/or reinforcement fibers during the hardening process.

The disclosure additionally relates to thermosetting plastic component manufactured in that way that can be joined to a thermoplastic component by a firm bond, especially by welding, wherein the thermosetting plastic component has a main body that comprises reinforcement fibers integrated into a cured thermosetting plastic matrix and is coated with a functional layer, at least in one joining area provided to be joined to the thermoplastic component.

Furthermore, the disclosure relates to a method for joining such thermosetting plastic component to a thermoplastic component by a firm bonding, especially welding, in which the two components are joined to one another via the functional layer of the thermosetting plastic component, and also to a composite part manufactured by such joining process.

### BACKGROUND

Owing to their strength and low weight, fiber composite parts are becoming increasingly important in aviation, space, and automobile engineering, where especially fiberglass-reinforced plastic (FRP) and increasingly carbon fiber-reinforced plastic (CFRP) are being used.

Fiber-reinforced components have reinforcement fibers, especially carbon fibers, glass fibers and/or aramid fibers that are embedded or integrated into a matrix, especially a thermoplastic and/or thermosetting plastic one. In this case, the reinforcement fibers, in particular, give the component the necessary strength or rigidity. On the other hand, the matrix has the primary effect of maintaining the reinforcement fibers in the desired shape. Thus, the reinforcement fibers are oriented, supported and protected by the matrix,

Due to the better mechanical properties—above all with regard to weight-specific strength and rigidity—fiber-reinforced components with a thermosetting plastic matrix are preferred for many applications. The cross-linking of the thermosetting plastics receives the name of curing, which can be a cross-linking polymerization or a polyaddition or polycondensation, for example. Since thermosetting plastics or the thermosetting plastic matrix cannot be melted any longer after the hardening process, the shaping of the fiber-reinforced thermosetting plastic component must take place before or during this hardening process. Furthermore, direct welding of a cured thermosetting plastic component to another one, especially a thermoplastic component, is not possible due to this property.

A joining method known from the state of the art is, for example, the bonding of thermosetting plastic components with thermoplastic components using a certain glue and/or bonding agent, especially a primer. However, the disadvantage is the long duration of the process owing to additional process steps and the resulting higher costs.

Moreover, known joining methods are the firm and/or force-fitting bonding of these components. Thus, they can be joined to one another with crews and/or rivets, but the disadvantage here is that the fiber structure of the fiber-reinforced thermosetting plastic component is damaged during the introduction and/or penetration of the fastening agents. As a result of this, the component loses strength. Alternatively or additionally, thermosetting plastic components can of course also be molded with a thermoplastic component to achieve a firm bond after curing. However, even when this method is used, a sufficiently firm connection between the two components cannot often be achieved. In addition, all these above-mentioned joining methods have the disadvantage of being very time consuming and expensive.

Furthermore, a manufacturing and joining method for thermosetting plastic carbon fiber composite parts is known from DE 10 2010 007 824 A1, in which a technically reliable composite is provided with the help of a resistance welding method. Carbon fiber textiles with fabric or flow structure are used as heating elements for resistance welding and are arranged between the two components to be joined. On their surface, the carbon fiber textiles are impregnated with a thermoplastic or fully soaked with it. With the help of such an impregnated carbon fiber textile and under pressure and higher temperature, two thermosetting plastic components are welded together or one thermosetting plastic component is welded to a thermoplastic component through an intermolecular bound thermoplastic foil.

However, the use of this foil has the disadvantage that it cannot be fully ensured—especially with complex component structures—that the entire surface of the attachment foil sits tightly on the thermosetting plastic component. These so-called dry spots weaken the connecting area between the thermosetting plastic component and the component joined with it. Furthermore, the manufacturing process that uses such kind of foil proves to be very time consuming and expensive.

Another disadvantage of this known joining method is that an impregnated carbon fiber textile must always be inserted between the two components to be joined together. As a result of this, the joining of the thermosetting plastic component to a thermoplastic component becomes very time consuming and expensive. In addition, there is always the danger—especially with complex component structures—that the impregnated carbon fiber textile arranged in the joining area will create folds, which then cause dry spots between the carbon fiber textile and at least one of the two components to be joined together, which leads, in turn, to a weakening of the joining area.

The task of the present invention is therefore to provide a manufacturing method for a fiber-reinforced thermosetting plastic component with a functional layer, create such fiber-reinforced thermoplastic component, provide a method for joining such fiber-reinforced thermosetting plastic component to a thermoplastic component, and create such a manufactured composite part with which the disadvantages mentioned above can be solved.

### SUMMARY

The task is solved by a the disclosed manufacturing method for a fiber-reinforced thermosetting plastic component, and/or with a thermosetting plastic component that can be joined to a thermoplastic component via a firm bond, and/or a method for joining a thermosetting plastic component to a thermoplastic component via a firm bond, and/or a related composite part.

A manufacturing method for an at least hardened, and also a fully-cured, fiber-reinforced thermosetting plastic component that can be joined to the thermoplastic component provided for this purpose via a firm bond connection is disclosed. In this manufacturing method, a thermoplastic or thermoplastic/thermosetting plastic functional layer is applied before or after a hardening process on a still unhardened thermosetting plastic main body in at least one joining area provided to be joined to the thermoplastic component. Here, the thermosetting plastic main body comprises reinforcement fibers, especially carbon fibers, and a viscous thermosetting plastic matrix. The at least partially coated main body is hardened and/or cured in a curing device under pressure and/or heat and then preferably given its final shape here. During this hardening process, the thermoplastic or thermoplastic/thermosetting plastic functional layer bonds firmly to the thermosetting plastic matrix and/or the reinforcement fibers of the main body. Via the thermoplastic/or thermoplastic/thermosetting plastic functional layer, the hardened or fully cured thermosetting plastic main body can be joined to the thermoplastic component provided for this purpose in a subsequent joining process after its manufacturing process has been completed.

Thus, a manufacturing method for a fiber-reinforced thermosetting plastic component that can be joined to a thermoplastic component via firm bond, especially by welding, is essentially disclosed. In the manufacturing method according to the disclosure, reinforcement fibers, especially carbon, glass or aramid fibers, are inserted in a curing device with a viscous thermosetting plastic matrix to create a main body, The reinforcement fibers can be provided in form of short-cut fibers, short-cut threads, bands, fabric mats, clutches and/or pre-pregs. Here, the term “pre-preg” refers to bands or fabric mats or fabric clutches that are pre-impregnated with a resin, preferably with a thermosetting plastic matrix material and/or pre-hardened where appropriate. The material used for the thermosetting plastic matrix is especially an epoxy resin or polyurethane resin, very preferably a one-, two- or three-component resin. The curing device can be an oven, autoclave or vacuum press. However, any other device suitable for hardening and/or curing the thermosetting plastic matrix is also conceivable.

The integration of the reinforcement fibers and the thermosetting plastic matrix can likewise take place in the most varied way. Thus, it is for example conceivable for the reinforcement fibers to be inserted individually, as fabric and/or clutch, into the curing device and then be surrounded and/or impregnated by spraying the viscous thermosetting plastic matrix with it. Alternatively or additionally, the combination of reinforcement fibers and thermosetting plastic matrix can also be inserted as pre-preg into the curing device, however. Needless to say, several such layers can also be applied on the curing device, especially on a tool shape.

After inserting the reinforcement fibers and the viscous thermosetting plastic matrix into the hardening matrix, the thermosetting plastic matrix is hardened and/or cured under pressure and/or heat. Before or after this hardening process, a functional layer is arranged on the (especially viscous) thermosetting plastic matrix and/or on the reinforcement fibers for coating the main body, at least in one joining area intended for joining to the thermoplastic component. Alternatively, however, the entire main body can be coated with such functional layer. During the hardening process, the functional layer joins the thermosetting plastic matrix and/or reinforcement fibers via a firm bond.

According to the disclosure, the functional layer is applied, preferably sprayed, before or during the hardening process on the (especially viscous) thermosetting plastic matrix and/or the reinforcement fibers, at least in the joining area or in one of these areas forming the joining area of the reinforcement fibers-matrix composite. Alternatively or additionally, however, the functional layer can also be sprayed on a tool shape of the curing device—especially before it is closed—at least in an area lying next to the joining area of the main body or the thermosetting plastic matrix during the hardening process. Spraying the functional layer can advantageously prevent dry spot areas where the entire surface of the functional layer does not lie tightly on the main body. Such dry spots occur especially in complex component structures when a foil is used as functional layer. Spraying the functional layer can ensure a full-surface and therefore very firm bonding between the functional layer and the main body in the joining area. Moreover, the fiber-reinforced thermosetting plastic component that is suitable for welding to a thermoplastic component can be made very economically and quickly by spraying the functional layer.

It is advantageous if the functional layer is applied, particularly sprayed, in liquid, paste, powder and/or granulate form because in this case the thickness of the functional layer can be controlled particularly well.

It is likewise advantageous if the functional layer has several layers, particularly an essentially thermosetting plastic first layer, a largely thermoplastic second layer and/or a thermoplastic/thermosetting plastic mixed layer arranged between these two. It is especially preferable if the first layer forms the adhesion interface with the main body and the second layer the joining surface for joining, especially welding, to the thermoplastic component intended for this purpose, Advantageously, the layers are applied—especially sprayed—one at a time on the tool shape and/or the main body.

It is also advantageous if the viscosity of the sprayed material that forms the functional layer is chosen in such a way that the material uniformly moistens the tool shape and/or main body, particularly if the component has a complex geometry and/or is not capable of essentially flowing away, which would cause the functional layer to tear open before or during the hardening process.

A sufficiently strong connection between the functional layer and the thermosetting plastic matrix and/or the reinforcement fibers can be ensured if the functional layer is joined to the thermosetting plastic matrix and/or the reinforcement fibers by adhesion during the hardening process. Therefore, the thermosetting plastic matrix and/or the reinforcement fibers are directly bonded, especially stuck together, to the functional layer without the need of additional agents such as a glue and/or primer. Thus, an adhesion interface is formed between the functional layer and the thermosetting plastic matrix and/or the reinforcement fibers. As a result of this, the functional layer has a very strong bond with the thermosetting plastic matrix and/or the reinforcement fibers, thereby largely ruling out a detachment of the functional layer from the main body.

It is advantageous if during the formation of the adhesion interface, the thermosetting plastic amounts of the thermoplastic/thermosetting plastic functional layer move towards the adhesion interface and the thermoplastic amounts move away from it during the hardening process. As a result of this, a stronger bond between the functional layer and the main body as well as the thermoplastic component intended for this purpose can be created.

Advantageously, the thermosetting plastic matrix is sprayed on the reinforcement fibers in a wet impregnation method, particularly before the functional layer is sprayed, is injected into the hardening device in an injection process, especially after the functional layer is sprayed, and/or is incorporated into the hardening device together with the reinforcement fibers as pre-preg.

It is likewise advantageous if the tool shape of the hardening device is pre-heated and/or maintained at a preferably constant temperature during the hardening process before spraying the functional layer. It is preferable for the temperature to be higher than or equal to the curing temperature of the thermosetting plastic matrix and/or of the thermosetting plastic used in the functional layer, preferably between 100° and 200° C., very preferably 120° C., and lower than the melting temperature of the thermoplastic used in the functional layer, preferably between 100° and 300° C., very preferably 200° C. Since the melting temperature of the thermoplastic is higher than the curing temperature of the thermosetting plastic, the latter hardens fully but the thermoplastic does not melt completely. Some areas of the functional layer can thus be advantageously prevented from tearing open because a thermoplastic heated above the melting temperature would flow away due to its increasing viscosity caused by this. Another advantage of the above-mentioned temperature ranges is that—especially in a thermoplastic/thermosetting plastic functional layer, the thermosetting plastics heated to the curing temperature start moving increasingly towards the main body, i.e. towards the adhesion interface that is being formed, whereas the thermoplastic amounts of the functional layer move increasingly towards the joining surface, in whose area the fiber-reinforced thermosetting plastic component can be later joined, especially welded, to the thermoplastic component intended for that purpose. As a result of this, the bonding connection between the functional layer and the fiber-reinforced thermosetting plastic component becomes advantageously stronger in the area of the adhesion interface. At the same time, however, the connecting quality of the fiber-reinforced thermosetting plastic component with the thermoplastic component intended for that purpose is improved by the higher thermoplastic concentration in the joining area of the functional layer.

According to the disclosure, the thermosetting plastic component that can be joined, especially welded, to a thermoplastic component has a main body that comprises reinforcement fibers, especially carbon, glass and/or aramid fibers, incorporated into a cured thermosetting plastic matrix, and that is formed, especially coated, with a functional layer in at least one joining area intended for joining to the thermoplastic component. The functional layer is a thermoplastic or thermoplastic/thermosetting plastic functional layer. The thermosetting plastic can thus be advantageously joined quickly and easily to a thermoplastic component as part of a welding or injection molding process,

An especially strong bonding between the main body and the functional layer as well as between the functional layer and the thermoplastic component intended for joining, especially welding, with it or the thermosetting plastic component can be ensured with a thermoplastic/thermosetting plastic functional layer. Thus, the thermosetting plastics of the functional layer, in particular, induce the formation of a particularly strong bond, especially adhesive bond, between the largely thermosetting plastic main body and the functional layer. At the same time, the thermoplastics of the functional layer produce a joining, especially welding, to the thermoplastic component intended for that purpose by forming an especially strong bond, particularly a welding connection.

Advantageously, the functional layer is a sprayed layer or a foil. A functional layer formed as a sprayed layer is characterized especially by the fact that essentially no dry spots are formed between it and the main body. Consequently, the entire surface of the functional layer or sprayed layer sits tightly on the main body. Preferably, the sprayed layer has been formed following a manufacturing method according to the description given above, wherein the characteristics mentioned can be present individually or in any combination.

A particularly strong bond between the functional layer and the main body can be ensured if an adhesion interface is formed between these two. Thus, the functional layer is directly joined, especially bonded, to the main body, particularly to the thermosetting plastic matrix and/or the reinforcement fibers.

It is also advantageous if the thermosetting plastic of the thermoplastic/thermosetting plastic functional layer is equal or at least extremely similar to the thermosetting plastic matrix. As a result of this, a very strong bond between the functional layer and the main body, especially its thermosetting plastic matrix and/or reinforcement fibers, can be ensured.

Preferably, the thermoplastic used in the functional layer is acrylonitrile-butadiene-styrene (ABS) or polyamide, especially polyamide 11 or 12. Alternatively, however, any other technically usable thermoplastic is conceivable as well. The preferred thermosetting plastic is especially a one-, two- or three-component epoxy resin or polyurethane resin.

To ensure a super strong bonding of the functional layer to the main body and at the same time to optimize to that effect the properties of this functional layer to bond to the thermoplastic component intended for this purpose so the functional layer forms an especially strong bond between the thermoplastic component and the fiber-reinforced thermosetting plastic component, it is advantageous for the amount of thermosetting plastic in the thermoplastic/thermosetting plastic functional layer to be greater in the adhesion interface area than in the area of its bonding surface intended for joining to the thermoplastic component. Thus, the small thermosetting plastic parts of the thermoplastic/thermosetting plastic functional layer present in higher concentration in the joining area with the main body make it possible for the functional layer to bond especially strongly, particularly to stick together, to the thermosetting plastic matrix of the fiber-reinforced main body. At the same time, the small thermosetting plastic parts present in higher concentration in the bonding surface of the functional layer allow it to join the thermoplastic component intended for this especially strongly.

Advantageously, the thermoplastic amount of the thermoplastic/thermosetting plastic functional layer is higher than the thermosetting plastic amount or the same. Thus, the thermoplastic amounts of the thermoplastic/thermosetting plastic functional layer, in particular, make a bonding, especially a welding, of the cured fiber-reinforced thermosetting plastic component to the thermoplastic component intended for this possible. In a largely balanced ratio of thermoplastics to thermosetting plastics, an advantageously very strong bonding between the functional layer and the fiber-reinforced thermosetting plastic component and a particularly strong bonding, especially welding, of the functional layer to the thermoplastic component intended for that purpose can be ensured.

In an advantageous further development of the disclosure, the functional layer has a thickness, particularly over its entire surface, from 10 μm to 1000 μm, especially from 150 μm to 750 μm. The functional layer has very preferably essentially a homogenous thickness over its entire surface. This ensures that when the thermoplastic component intended for this purpose is welded on to the functional layer, it does not melt through, so that the thermoplastic component would sit tightly on the thermosetting plastic component. This would cause a weakening of the joining area between the two, especially welded-together, components. The spraying method can form an especially thin functional layer, which can lower the manufacturing costs of the fiber-reinforced thermosetting plastic component.

Furthermore, and especially owing to the above-mentioned spraying method, dry spots between the functional layer and the main body can be prevented. Thus, the entire surface of the functional layer advantageously fits closely on the main body, thereby sticking very strongly together to the main body, especially over its entire contact area.

It is advantageous if the thermosetting plastic component or main body is coated with a functional layer in several separated or at least overlapping areas. In this way, several spots of the thermosetting plastic component can be advantageously joined, especially welded, to one or several thermoplastic components. It is also advantageous for the functional layers to have the same thickness and/or different ones relative to one another.

In a method according to the disclosure to join a thermosetting plastic component to a thermoplastic component through a firm bond, especially welding, these two components are joined to one another via a functional layer of the thermosetting plastic component. In this case, the thermoplastic component is directly connected, especially welded on to, by creating a diffusion area between the thermoplastic component and the functional layer of the thermosetting plastic component. A diffusion area is characterized by uniform transfer of material from the thermoplastic component to the functional layer of the thermosetting plastic component. The diffusion area has preferably a thickness from 20 μm to 40 μm and ensures a very strong bond between the thermoplastic component applied, especially welded on to, and the thermosetting plastic component, especially reinforced with fibers. Furthermore, this joining method represents a very economical and fast bonding of fiber-reinforced thermosetting plastic components, in particular, to thermoplastic components.

It is advantageous if the thermosetting plastic component is manufactured and/or formed according to the preceding description, wherein the above-mentioned processing steps and characteristics can be present individually or in any combination.

An especially fast and uncomplicated joining of the thermosetting plastic component to the thermoplastic component can take place if the latter and/or the functional layer of the thermosetting plastic component is preheated and/or melted on, especially in some areas, and the melted-on thermoplastic component is pressed on the functional layer of the thermosetting plastic component.

Alternatively, particularly in an injection molding process, the thermosetting plastic component can be inserted in an injection mold—but especially also as a pre-hardened or cured insert—and subsequently injection molded, especially after closing the tool, with a thermoplastic molten mass to form the thermoplastic component. Here, the thermoplastic component is injection molded as thermoplastic molten mass directly on the functional layer of the thermosetting plastic component. This manufacturing method is especially well suited for complex composite parts having an outer contour, surface and/or cover formed by the fiber-reinforced thermosetting plastic component and a functional element formed by the thermoplastic component, particularly a brace, holding element and/or fastener, injected on the inner side of the thermosetting plastic component. Suitable injection molds include two or more injection mold parts. One or several injection mold parts have one or several injection channels through which the viscous thermoplastic material is injected.

According to the disclosure, the composite part has at least one thermosetting plastic component and at least one thermoplastic component joined together by at least one functional layer. The thermoplastic component is directly joined, especially welded, to the functional layer of the thermosetting plastic component. As a result of this, such composite parts can be manufactured very quickly and economically. A diffusion area has been formed between the thermoplastic component and the functional layer, thereby ensuring a particularly strong bond between the thermoplastic component and the thermosetting plastic component.

It is especially advantageous if the thermosetting plastic component is manufactured, formed and/or joined to the thermoplastic component according to the description given above, wherein the above-mentioned characteristics of the process and physical characteristics can be present individually or in any combination.

To ensure an especially strong bond between the thermosetting plastic component and the thermoplastic component, it is advantageous if the functional layer separates the thermoplastic component in the thermosetting plastic component joining area from its thermosetting plastic main body. Thus, the functional layer is not fully penetrated when the thermoplastic component is applied, especially welded on to it. Instead, a very strong bond between the thermoplastic component and the thermosetting plastic component is ensured over their entire contact area via the functional layer because it has formed an adhesion interface by sticking to the main body, and a diffusion area by bonding, especially welding, to the thermoplastic component.

It is also advantageous if the thermoplastic of the thermoplastic component is equal or very similar to that of the thermoplastic or thermoplastic/thermosetting plastic functional layer. As a result of this, a diffusion area can be formed to ensure a very strong bond of the thermoplastic component to the thermosetting plastic component.

Especially in the case of a thermoplastic/thermosetting plastic functional layer, the connecting surface on which the thermoplastic component is applied, especially welded on, is formed with a higher thermoplastic amount with regard to the area forming the adhesion interface. Consequently, in the joining area with the thermoplastic component or with the connecting area of the functional layer, the functional layer creates with higher thermoplastic amounts or a higher thermoplastic concentration a very strong bond with the thermoplastic component that has been welded on. All industrially usable thermoplastics are suitable, particularly ABS and/or polyamides, especially polyamide 11 and/or 12.

### BRIEF DESCRIPTION OF THE DRAWINGS

Additional advantages of the invention are described in the following embodiments, which show:

FIG. 1 is a cross-sectional view of an area of a fiber-reinforced thermosetting plastic component with a functional layer.

FIG. 2 is a cross-sectional view of an area of a fiber-reinforced thermosetting plastic component and a thermoplastic component before joining, especially welding.

FIG. 3 is a cross-sectional view of a joining area of a composite part with a thermoplastic component in cross section connected, especially welded on, to a functional layer of the thermosetting plastic component.

### DETAILED DESCRIPTION

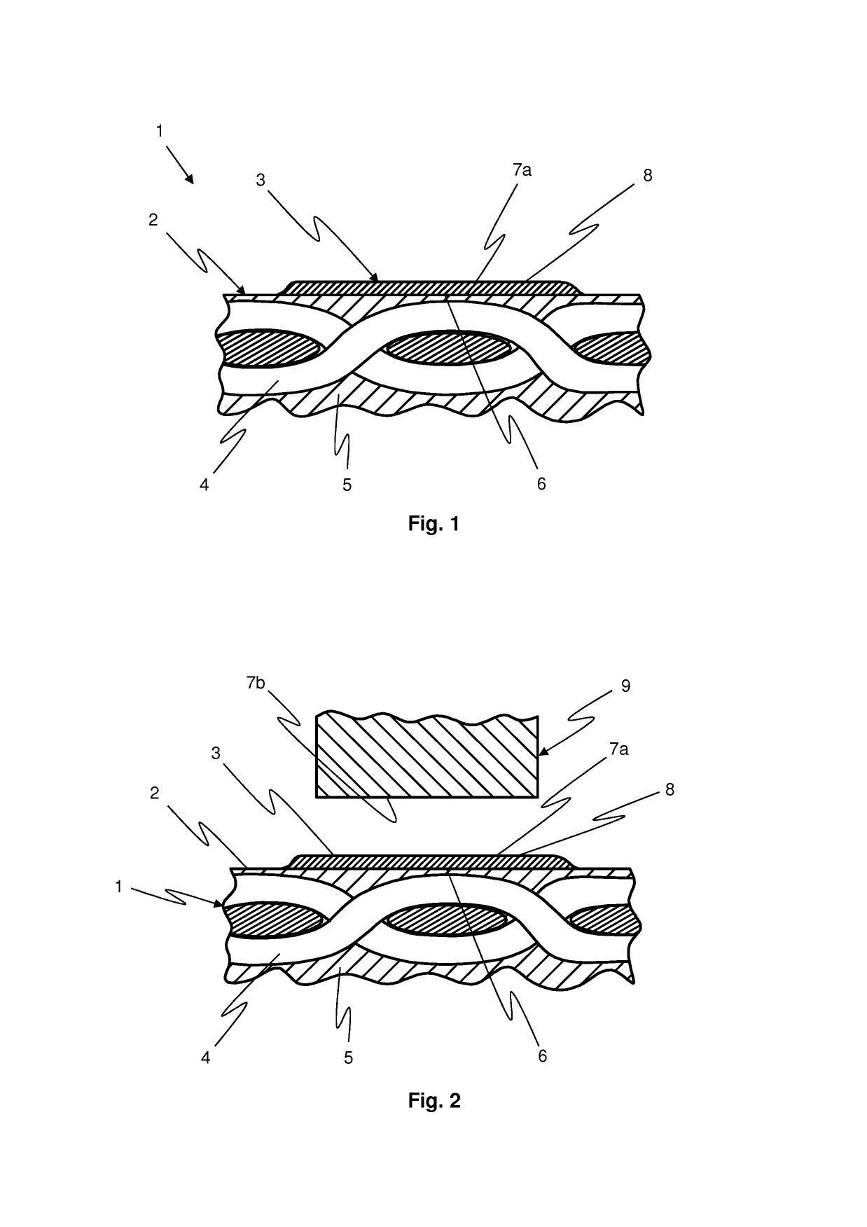

FIG. 1 shows a cross section through a thermosetting plastic component 1 that comprises a main body 2 and a functional layer 3. Here, the thermosetting plastic component 1 is formed as a fiber-reinforced thermosetting plastic component. Thus, the main body 2 comprises reinforcement fibers 4 embedded in a plastic matrix 5. The reinforcement fibers can be made of glass, carbon and/or aramid fibers. In this embodiment, the reinforcement fibers 4 are formed as carbon fibers. The carbon fibers can be formed as short-cut fibers, short-cut threads, bands, or as is the case here, as fabric mats in the main body 2. Furthermore, it is also conceivable for the reinforcement fibers to be incorporated as clutches, i.e. at least two fabric mats placed above one another. The matrix 5 is here a thermosetting plastic, especially an epoxy resin or polyurethane resin. The thermosetting plastic matrix 5 is cured here and gives the reinforcement fibers 4 dimensional stability. The reinforcement fibers 4 serve primarily to give the main body 2 or thermosetting plastic component 1 the needed strength.

The thermosetting plastic main body 2 can have any form. Thus, the main body 2 can be, for example, a vehicle body part or also its inner covering. Usually, such thermosetting plastic main bodies or thermosetting plastic components have complex structural geometry, particularly with free-forming surfaces and/or undercuts.

A basic problem that such thermosetting plastic components have is that after curing they can only be joined to additional components using very time-consuming and expensive methods. Additionally, these methods have the disadvantage that the bonding quality is not particularly good so the danger exists that these two components will detach from one another if subject to a load.

According to the disclosure and FIG. 1, the thermosetting plastic component 1 therefore has the functional layer 3, which is a thermoplastic or a mixture from a thermoplastic and thermosetting plastic. In a thermoplastic/thermosetting plastic functional layer 3, the proportion of thermosetting plastic to thermoplastic is preferably 1:4, 1:3, 1:2 or very preferably 1:1.

The functional layer 3 is directly joined to the main body 2 via adhesion, especially stuck together. Thus, an adhesion interface 6 has been formed between the functional layer 3 and the main body 2. In this case, the functional layer 3 can—as shown in FIG. 1—be joined exclusively to the thermosetting plastic matrix 5 of the main body or also additionally or alternatively to the reinforcement fibers 4. The adhesion interface 6 represents a clear transition from the thermosetting plastic matrix 5 to the thermoplastic or thermoplastic/thermosetting plastic functional layer 3. No diffusion area has been formed between them. Also, no joining agent, especially glue and/or primer, has been arranged.

The functional layer 3 is arranged in a joining area 7a of the thermosetting plastic component 1. On its side that faces away from the main body 2, the functional layer 3 has a connecting area 8 on which the thermoplastic component 9 intended for this purpose can be connected, especially welded (cf. FIGS. 2 & 3). The thermosetting plastic component 1 can also have several joining areas 7a formed in this way in which it is possible to be connected, especially welded, to one or several thermoplastic components 9.

Compared to the main body 2, the functional layer 3 has been formed very thinly. Preferably, it has a thickness from 10 μm to 1000 μm, especially from 150 μm to 750 μm. Especially preferable, however, is a very thin functional layer 3 having a thickness from 10 μm to 250 μm, especially up to 200 μm, very preferably up to 150 μm.

Such thin functional layers can be made through a spraying process. To achieve this, the reinforcement fibers 4, especially carbon fibers, are inserted into the viscous thermosetting plastic matrix 5 to form the main body in a curing device not shown here. Such a curing device can be an oven, autoclave or vacuum press, for example. In this curing device, the thermosetting plastic matrix 5 is hardened and/or cured under pressure and/or heat. However, before this hardening process, it is provided with the functional layer 3 in the joining area 7a, in which the thermosetting plastic component 1 will be joined, especially welded, to the thermoplastic component 9 intended for this purpose.

To make such a functional layer 3 very thin compared to foils, it is sprayed on the viscous thermosetting plastic matrix 5 and/or the reinforcement fibers 4 before or during the hardening process. Alternatively or additionally, the thermoplastic or thermoplastic/thermosetting plastic mixture forming the functional layer 3 can be sprayed on a tool shape of the curing device not shown here. In this case, it is especially advantageous if the thermoplastic and/or thermosetting plastic, with which the functional layer 3 is formed, sits tightly on the joining area 7a of the main body 2 in the area of the tool shape that is being sprayed during the hardening process. After spraying the functional layer 3 on the tool shape by placing the reinforcement fibers 4 together with the viscous thermosetting plastic matrix 5, especially as pre-preg, contact between the functional layer 3 and the main body 2 can take place in the tool shape. Alternately, however, contact can also take place until the tool is closed and/or the viscous thermosetting plastic matrix 5 is injected into the closed tool. The very strong adhesion interface 6 via which the functional layer 3 is joined to the main body 2 is formed during the ensuing hardening process, wherein no additional glues and/or primers are used.

An important advantage of the method according to the disclosure in which the functional layer is sprayed is that the entire surface of the functional layer 3 sits tightly on the main body 2. This is particularly noticeable in a complex structural geometry because in this case a functional layer 3 formed as foil would form so-called dry spots that eventually would weaken the bond between functional layer 3 and main body 2.

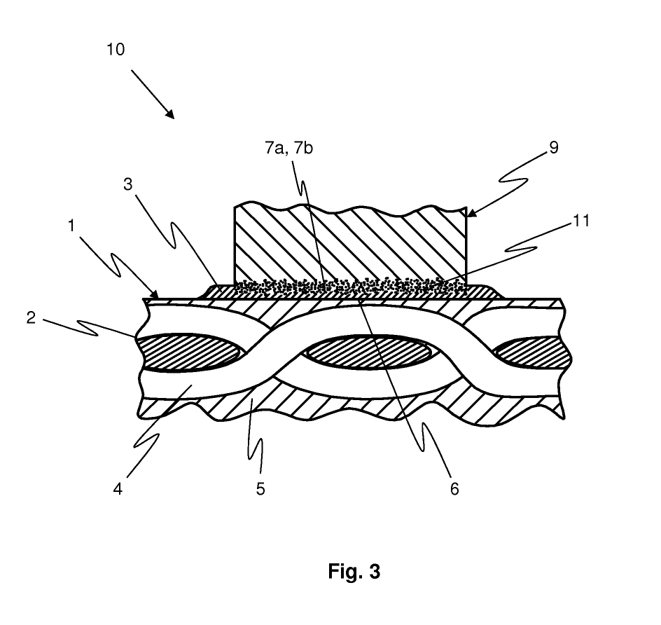

A very good adhesion of the functional layer 3 to the main body 2 and at the same time a very strong connection, especially welding connection, to the thermoplastic component 9 shown in FIG. 3 can be ensured if the functional layer 3 has both thermoplastic and thermosetting plastic amounts. Such a thermoplastic/thermosetting plastic functional layer 3 is characterized especially by the fact that the thermosetting plastic amounts of the functional layer 3 are higher in the area of the adhesion interface 6 than in the connecting surface 8 intended for connection to the thermoplastic component 9. Furthermore, a very strong adhesion between functional layer 3 and main body 2 is favored if the thermosetting plastic of the thermoplastic/thermosetting plastic functional layer 3 is identical or is at least very similar to the thermosetting plastic matrix 5. Suitable thermosetting plastics for this are preferably epoxy resins or polyurethane resins.

FIG. 2 shows a partial area of the fiber-reinforced thermosetting plastic component 1 in cross section before it is joined, especially welded, to the thermoplastic component 9. To achieve this, the fiber-reinforced thermosetting plastic component 1 can be placed as insert into an injection molding device not shown here and be joined, especially welded, to it by direct spraying of the thermoplastic component 9 available as thermoplastic molten mass in the area of the joining area 7a of the thermosetting plastic component 1. Thus, the thermoplastic molten mass is joined, especially welded, to the functional layer 3 of the thermosetting plastic component 1, at the same time forming—in conjunction with the injection mold—the final shape of the thermoplastic component 9 as functional element.

Alternatively, however, some areas of the finished thermoplastic component 9 can, especially as functional element, also be pre-heated and/or melted on in its joining area 7b, and while this occurs or after this preheating and/or melting process has been completed, be pressed with its melted-on joining area 7b on the functional layer 3 of the thermosetting plastic component 1, in its joining area 7a. In this case, the thermoplastic component 9 is melted with the functional layer 3. Additionally or alternatively, however, the functional layer 3 can also be preheated and/or melted on. This joining process can take place in a bonding device made for this purpose.

A composite part 10 shown in FIG. 3 is manufactured via the two methods mentioned above. It is characterized by the fact that the thermoplastic component 9 is joined, especially welded, to the fiber-reinforced thermosetting plastic part 1, wherein the connection between these two parts is made possible by the functional layer 3. When the thermoplastic component 9 is being joined, especially welded, to the thermosetting plastic component 1, a diffusion area 11 is formed between the functional layer 3 of the thermosetting plastic part 1 and the thermoplastic part 9. This diffusion area 11 is very strongly formed when the thermoplastic of the thermoplastic component 9 is identical to the thermoplastic or thermoplastic/thermosetting plastic functional layer 3 or at least very similar to it. Suitable for this is any industrially usable thermoplastic, but particularly suitable is ABS and/or a polyamide, especially polyamide 11 and/or 12.

As can be recognized in the cross-sectional view shown in FIG. 3, the functional layer 3 cannot be fully melted on. The fiber-reinforced thermosetting plastic main body 2 of the thermosetting plastic component 1 and the thermoplastic component 9 joined with it are therefore separated by a remaining part of the thermoplastic or thermoplastic/thermosetting plastic functional layer 3. According to FIG. 3, the joining areas 7a, 7b of the two parts are melted together and as a result of this form the diffusion area 11, which ensures a very firm bond between the thermoplastic part 9 and the thermosetting plastic component.

FIGS. 1 & 3 show in each case only a section of a thermosetting plastic component and/or a thermoplastic component 9 or one composite part 10 comprising one of these two components. The thermosetting plastic component 1 can have several joining areas 7a formed in this way in which it can be joined or is already joined to one or several thermoplastic components 9, which are preferably functional elements, especially reinforcing braces and/or fastening areas, preferably clips, eyelets or the like. It is also conceivable for the entire surface of the thermosetting plastic component to be coated with the corresponding functional layer 3. To achieve this, it is recommended to spray the entire surface of the thermosetting plastic component 1, especially its main body 2, with a thermoplastic available in liquid, paste, powder and/or granulate form so the functional layer 3 can be formed before it is cured.

The present invention is not restricted to the embodiments shown and described here. Deviations within the framework of the patent claims are just as possible as a combination of the characteristics, even if they are shown and described in different embodiments.

### LIST OF REFERENCE CHARACTERS

1 Thermosetting plastic component
2 Main body
3 Functional layer
4 Reinforcement fibers
5 Thermosetting plastic matrix
6 Adhesion interface
7 Joining area
8 Connecting surface
9 Thermoplastic component
10 Composite part
11 Diffusion area

1. A method for manufacturing an at least hardened fiber-reinforced thermosetting plastic component that can be joined to a thermoplastic component via a firm bond, the method comprising the steps of:
applying one of a thermoplastic and thermoplastic/thermosetting plastic functional layer, at least in a joining area for joining to the thermoplastic component at least as early as during a hardening step on an unhardened thermosetting plastic main body which includes reinforcement fibers and a viscous thermosetting plastic matrix; and
at least hardening the main body in a curing device under at least one of pressure and heat so that the functional layer is joined to the main body via a firm bond, and so that the at least hardened main body can be joined in a subsequent joining process to the thermoplastic component via the functional layer.

2. A method according to claim 1, wherein the functional layer is applied on a tool shape of the curing device, at least in a tool shape area fitting tightly on the joining area during the hardening step.

3. A method according to claim 1, wherein the functional layer is joined to the main body through adhesion so that an adhesion interface is formed between the functional layer and the main body, and wherein the functional layer includes the thermosetting/thermoplastic plastic and during the hardening step the thermosetting plastic of the thermoplastic/thermosetting plastic move towards the adhesion interface and the thermoplastic moves away from the adhesion interface.

4. A method according to claim 1, wherein the thermosetting plastic matrix is one of sprayed on the reinforcement fibers in a wet impregnation process, injected into the curing device in an injection process, and inserted as a pre-preg into the curing device together with the reinforcement fibers.

5. A method according to claim 2, wherein during the hardening step, the tool shape of the curing device is at least one of preheated to a temperature before the functional layer is sprayed on and maintained at a temperature that is at least equal to a curing temperature of at least one of the thermosetting plastic matrix and of the thermosetting plastic of the functional layer, and lower than a melting temperature of the thermoplastic of the functional layer.

6. A thermosetting plastic component for welding to a thermoplastic component, the thermosetting plastic component comprising:
a cured thermosetting plastic main body;
reinforcement fibers integrated into a thermosetting plastic matrix; and
a functional layer at least in a joining area for joining to the thermoplastic component, the functional layer including one of a thermoplastic and thermoplastic/thermosetting plastic.

7. A thermosetting plastic component according to claim 6, wherein the functional layer is one of a sprayed layer and a foil, the functional layer being joined directly to the main body in such a way that an adhesion interface is formed between the functional layer and the main body.

8. A thermosetting plastic component according to claim 6, wherein functional layer includes the thermosetting/thermoplastic plastic and a composition of the thermosetting plastic of the functional layer is at least very similar to that one of the thermosetting plastic matrix.

9. A thermosetting plastic component according to claim 6, wherein the functional layer includes the thermosetting/thermoplastic plastic and an amount of the thermosetting plastic of the functional layer is greater in an area of the adhesion interface than in an area of a connecting surface for joining to the thermoplastic component.

10. A thermosetting plastic component according to claim 6, wherein the functional layer includes the thermosetting/thermoplastic plastic and an amount of the thermoplastic of the functional layer is at least equal to an amount of the thermosetting plastic.

11. A thermosetting plastic component according to claim 6, wherein the functional layer has a substantially homogenous thickness from 10 μm to 1000 μm over its entire surface.

12. A method for joining a thermoplastic component to a cured thermosetting plastic component manufactured according to the method of claim 1, the method for joining comprising:
joining together the thermoplastic component and the thermosetting plastic component via a functional layer of the thermosetting plastic component so that the thermoplastic component is welded directly to the functional layer of the cured thermosetting plastic component so that a diffusion area is formed between the thermoplastic component and the functional layer of the thermosetting plastic component.

13. A method according to claim 12, wherein at least one of the thermoplastic component and the functional layer are at least one of preheated, melted on, or pressed against one another before welding at least in their respective joining areas.

14. A composite part comprising:
a cured thermosetting plastic component manufactured according to the method of claim 1; and
a thermoplastic component welded directly to a functional layer of the cured thermosetting plastic component so that a diffusion area is formed between the thermoplastic component and the functional layer.

15. A composite part according to claim 14, wherein the functional layer includes the thermosetting/thermoplastic plastic, and a composition of the thermoplastic of the thermoplastic component is at least very similar to that of the functional layer.

16. A method according to claim 1, wherein the functional layer is transferred to the unhardened main body when the tool shape is closed.

17. A method according to claim 5, wherein the curing temperature is between 100° C. and 200° C. and the melting temperature is between 100° C. and 300° C.

18. A method according to claim 17, wherein the curing temperature is about 120° C. and the melting temperature is about 200° C.

19. A thermosetting plastic component according to claim 11, wherein the thickness is from about 150 μm to about 750 μm

20. A method according to claim 12, wherein at least one of the cured thermosetting plastic component is inserted as insert in an injection mold in an injection molding process and the thermoplastic component is sprayed as thermoplastic molten mass directly on the functional layer of the thermosetting plastic component.
